(19) United States
(12) Patent Application Publication
(10) Pub. No.: US 2020/0128256 A1
(43) Pub. Date: Apr. 23, 2020

(54) METHOD AND APPARATUS FOR ENCODING OR DECODING A FLAG DURING VIDEO DATA ENCODING

(71) Applicant: CANON KABUSHIKI KAISHA, Tokyo (JP)

(72) Inventors: Guillaume LAROCHE, SAINT AUBIN D'AUBIGNE (FR); Patrice ONNO, RENNES (FR); Christophe GISQUET, ACIGNE (FR); Jonathan TAQUET, TALENSAC (FR)

(21) Appl. No.: 16/626,853

(22) PCT Filed: Jun. 22, 2018
(86) PCT No.: PCT/EP2018/066785

§ 371 Date: Dec. 26, 2019

(30) Foreign Application Priority Data
Jun. 30, 2017 (GB) 1710539.6

(51) Int. Cl. H04N 19/159; H04N 19/56; H04N 19/119; H04N 19/139; H04N 19/176; H04N 19/91; H04N 19/105

(52) U.S. Cl. CPC H04N 19/159; H04N 19/56; H04N 19/119; H04N 19/105; H04N 19/176; H04N 19/91; H04N 19/139

(57) ABSTRACT

The present disclosure concerns a method for decoding video data comprising frames, each frame being split into blocks of pixels, the method comprising for a block of pixels: obtaining from video data a mode information indicating whether the block of pixels is encoded according to a first mode where motion information is obtained by a decoder side motion vector derivation method; decoding the mode information based on a context information; wherein the context information is determined based on at least one of the following information: an information indicating for the block of pixels indicating to skip the decoding of the block of pixels or of a neighbouring block of pixels; an information relative to the shape of the block of pixels or of a neighbouring block of pixels; an information relative to the size of the block of pixels or of a neighbouring block of pixels; an information relative to a second mode used to encode a neighbouring block of pixels.

### PRIORITY CLAIM/INCORPORATION BY REFERENCE

This application claims the benefit under 35 U.S.C. § 119(a)-(d) of United Kingdom Patent Application No. 1710539.6, filed on 30 Jun. 2017 and entitled “METHOD AND APPARATUS FOR ENCODING OR DECODING A FLAG DURING VIDEO DATA ENCODING”. The above cited patent application is incorporated herein by reference in its entirety.

### FIELD OF THE INVENTION

The present disclosure concerns a method and a device for encoding or decoding video data. It concerns more particularly the encoding of a particular flag used to signal the use of a decoder side motion vector derivation mode referenced as frame-rate up conversion mode or FRUC mode.

### BACKGROUND OF INVENTION

Predictive encoding of video data is based on the division of frames into blocks of pixels. For each block of pixels, a predictor block is searched in available data. The predictor block may be a block in a reference frame different from the current one in INTER coding modes, or generated from neighbouring pixel in the current frame in INTRA coding modes. Different encoding modes are defined according to different way of determining the predictor block. The result of the encoding is an indication of the predictor block and a residual block consisting in the difference between the block to be encoded and the predictor block.

Regarding INTER coding modes, the indication of the predictor block is a motion vector giving the location in the reference image of the predictor block relatively to the location of the block to be encoded. The motion vector is itself predictively encoded based on a motion vector predictor. The HEVC (High Efficiency Video Coding) standard defines several known encoding modes for predictive encoding of motion vectors, namely the AMVP (Advanced Motion Vector Prediction) mode, the merge derivation process. These modes are based on the construction of a candidate list of motion vector predictor and the signalling of an index of the motion vector predictor in this list to be used for encoding. Typically, a residual motion vector is also signalled.

Recently, a new coding mode regarding the motion vector prediction has been introduced, named FRUC, that defines a derivation process of the motion vector predictor with no signalling at all. The result of the derivation process is to be used as the motion vector predictor without any transmission of an index or a residual motion vector by the decoder. Of course, there is still the need to transmit a flag to signal the use of the FRUC coding mode along with an additional FRUC mode flag to indicate the mode used by FRUC between two possible modes, namely template matching of bilateral matching. These flag are encoded in the bitstream using entropic coding, namely using CABAC (Context-Adaptive Binary Arithmetic Coding) as usually done in video coding recent standards like HEVC.

In some cases, experiments have proven that the gain offered by the FRUC mode may be cancelled by the cost of the transmission of the FRUC signalling flags.

### SUMMARY OF THE INVENTION

The present invention has been devised to address one or more of the foregoing concerns. It concerns an improved entropic coding scheme for encoding FRUC signalling flags.

According to a first aspect of the invention there is provided a method for decoding video data comprising frames, each frame being split into blocks of pixels, the method comprising for a block of pixels:
obtaining from video data a mode information indicating whether the block of pixels is encoded according to a first mode where motion information is obtained by a decoder side motion vector derivation method;
decoding the mode information based on a context information;
wherein the context information is determined based on at least one of the following information:
an information indicating for the block of pixels indicating to skip the decoding of the block of pixels or of a neighbouring block of pixels;
an information relative to the shape of the block of pixels or of a neighbouring block of pixels;
an information relative to the size of the block of pixels or of a neighbouring block of pixels;
an information relative to a second mode used to encode a neighbouring block of pixels.

In an embodiment, the context information is further determined based on corresponding mode information of at least one neighbouring block of pixels.

In an embodiment, the mode information is entropic encoded.

In an embodiment, a probability model used for entropic decoding of the mode information is determined based on the context information.

In an embodiment, the second mode is AMVP and the context information is further determined based on:
whether the motion vector residual is equal to 0; and
the predictor index is equal to 0.

According to another aspect of the invention there is provided a method for decoding video data comprising frames, each frame being split into blocks of pixels, the method comprising for a block of pixels:
obtaining from video data an mode information indicating whether the block of pixels is encoded according to a first mode where motion information is obtained by a decoder side motion vector derivation method;
decoding the mode information based on a context information;
wherein the method further comprises:
determining the context information based on the value of neighbouring pixels.

In an embodiment, the mode information is entropic encoded.

In an embodiment, a probability model used for entropic decoding of the mode information is determined based on the context information.

In an embodiment, determining the context information based on the value of neighbouring pixels comprises:
determining whether the sum of gradient or absolute gradient of neighbouring pixels values is less than a threshold.

In an embodiment, the gradients are obtained by derivatives in horizontal and vertical directions.

According to another aspect of the invention there is provided a method for encoding video data comprising frames, each frame being split into blocks of pixels, the method comprising for a block of pixels the comparison of a plurality of modes, the plurality of modes comprising at least a Merge mode and a mode where motion information is obtained by a decoder side motion vector derivation method:
determining a best candidate for a motion information using the Merge mode;
determining if the best candidate has a residual;
determining a best candidate using the mode where motion information is obtained by a decoder side motion vector derivation method; wherein:
if the best candidate using the Merge mode has no residual then, when determining the best candidate using the mode where motion information is obtained by a decoder side motion vector derivation method, candidates with residual are not evaluated.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates the HEVC encoder logical architecture;

FIG. 2 illustrates the HEVC decoder logical architecture;

FIG. 3 illustrates the template matching and the bilateral template matching;

FIG. 4 illustrates decoding of the FRUC Merge information;

FIG. 5 illustrates the context derivation and the decoding of the FRUC Merge flag;

FIG. 6 illustrates the encoder evaluation of the Merge mode and the Merge FRUC mode;

FIG. 7 illustrates the context derivation and the decoding of the FRUC Merge flag for one embodiment of the invention;

FIG. 8 illustrates the context derivation and the decoding of the FRUC Merge flag for another embodiment of the invention;

FIG. 9 illustrates the current block and its neighbouring pixels used in one embodiment of the invention;

FIG. 10 illustrates the encoder evaluation of the Merge mode and the Merge FRUC mode for one embodiment of the invention;

FIG. 11 is a schematic block diagram of a computing device for implementation of one or more embodiments of the invention.

### DETAILED DESCRIPTION OF THE INVENTION

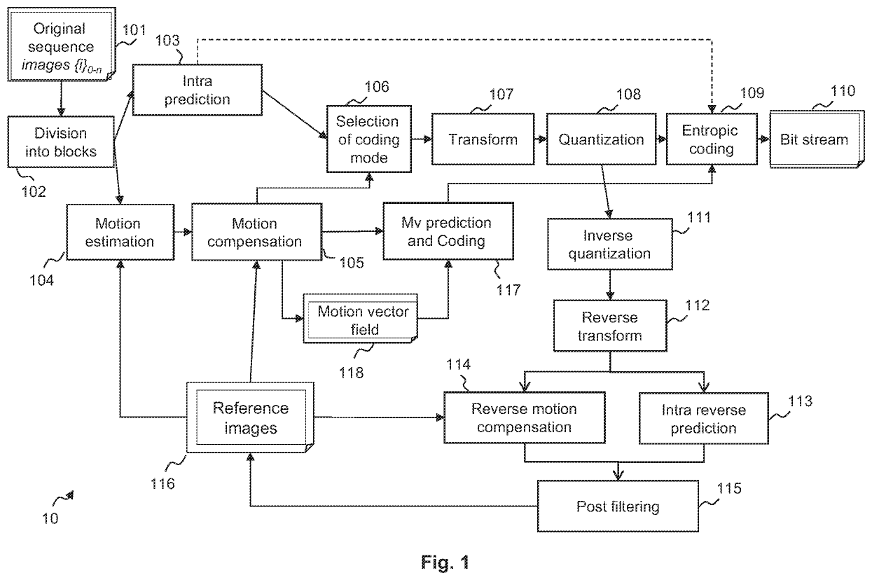

FIG. 1 illustrates the HEVC encoder architecture. In the video encoder, an original sequence 101 is divided into blocks of pixels 102 called coding units. A coding mode is then affected to each block. There are two families of coding modes typically used in HEVC: the modes based on spatial prediction or INTRA modes 103 and the modes based on temporal prediction or INTER modes based on motion estimation 104 and motion compensation 105. An INTRA Coding Unit is generally predicted from the encoded pixels at its causal boundary by a process called INTRA prediction.

Temporal prediction first consists in finding in a previous or future frame called the reference frame 116 the reference area which is the closest to the Coding Unit in a motion estimation step 104. This reference area constitutes the predictor block. Next this Coding Unit is predicted using the predictor block to compute the residue in a motion compensation step 105.

In both cases, spatial and temporal prediction, a residual is computed by subtracting the Coding Unit from the original predictor block.

In the INTRA prediction, a prediction direction is encoded. In the temporal prediction, at least one motion vector is encoded. However, in order to further reduce the bitrate cost related to motion vector encoding, a motion vector is not directly encoded. Indeed, assuming that motion is homogeneous, it is particularly interesting to encode a motion vector as a difference between this motion vector, and a motion vector in its surrounding. In H.264/AVC coding standard for instance, motion vectors are encoded with respect to a median vector computed between 3 blocks located above and on the left of the current block. Only a difference, also called residual motion vector, computed between the median vector and the current block motion vector is encoded in the bitstream. This is processed in module “Mv prediction and coding” 117. The value of each encoded vector is stored in the motion vector field 118. The neighbouring motion vectors, used for the prediction, are extracted from the motion vector field 118.

Then, the mode optimizing the rate distortion performance is selected in module 106. In order to further reduce the redundancies, a transform, typically a DCT, is applied to the residual block in module 107, and a quantization is applied to the coefficients in module 108. The quantized block of coefficients is then entropy coded in module 109 and the result is inserted in the bitstream 110.

The encoder then performs a decoding of the encoded frame for the future motion estimation in modules 111 to 116. These steps allow the encoder and the decoder to have the same reference frames. To reconstruct the coded frame, the residual is inverse quantized in module 111 and inverse transformed in module 112 in order to provide the “reconstructed” residual in the pixel domain. According to the encoding mode (INTER or INTRA), this residual is added to the INTER predictor 114 or to the INTRA predictor 113.

Then, this first reconstruction is filtered in module 115 by one or several kinds of post filtering. These post filters are integrated in the encoded and decoded loop. It means that they need to be applied on the reconstructed frame at encoder and decoder side in order to use the same reference frame at encoder and decoder side. The aim of this post filtering is to remove compression artefacts.

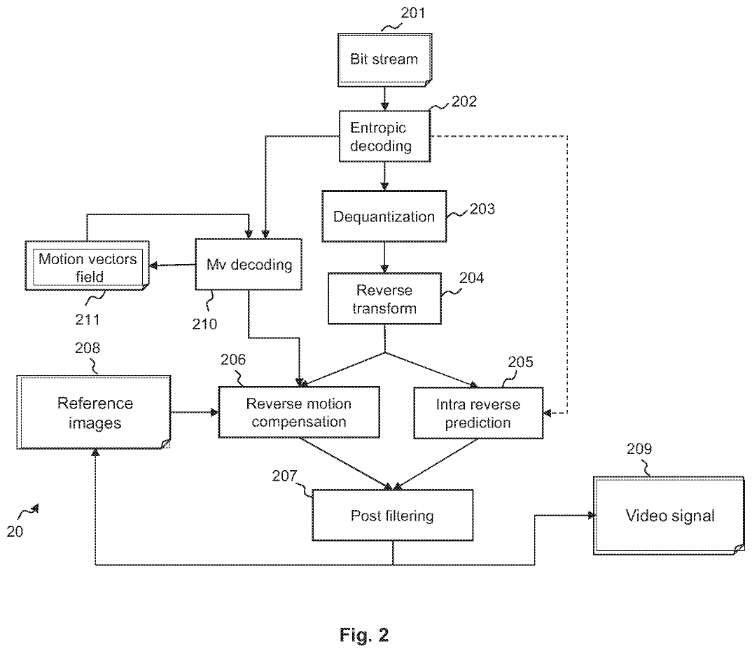

In FIG. 2, have been represented the principle of a decoder. The video stream 201 is first entropy decoded in a module 202. The residual data are then inverse quantized in a module 203 and inverse transformed in a module 204 to obtain pixel values. The mode data are also entropy decoded in function of the mode, an INTRA type decoding or an INTER type decoding is performed. In the case of INTRA mode, an INTRA predictor is determined in function of the INTRA prediction mode specified in the bitstream 205. If the mode is INTER, the motion information is extracted from the bitstream 202. This is composed of the reference frame index and the motion vector residual. The motion vector predictor is added to the motion vector residual to obtain the motion vector 210. The motion vector is then used to locate the reference area in the reference frame 206. Note that the motion vector field data 211 is updated with the decoded motion vector in order to be used for the prediction of the next decoded motion vectors. This first reconstruction of the decoded frame is then post filtered 207 with exactly the same post filter as used at encoder side. The output of the decoder is the de-compressed video 209.

The HEVC standard uses 3 different INTER modes: the Inter mode, the Merge mode and the Merge Skip mode. The main difference between these modes is the data signalling in the bitstream. For the Motion vector coding, the current HEVC standard includes a competitive based scheme for Motion vector prediction compared to its predecessors. It means that several candidates are competing with the rate distortion criterion at encoder side in order to find the best motion vector predictor or the best motion information for respectively the Inter or the Merge mode. An index corresponding to the best predictors or the best candidate of the motion information is inserted in the bitstream. The decoder can derive the same set of predictors or candidates and uses the best one according to the decoded index.

The design of the derivation of predictors and candidates is very important to achieve the best coding efficiency without large impact on complexity. In HEVC two motion vector derivations are used: one for Inter mode (Advanced Motion Vector Prediction (AMVP)) and one for Merge modes (Merge derivation process).

Both standardization groups ITU-T VCEG (Q6/16) and ISO/IEC MPEG (JTC 1/SC 29/WG 11) which have defined the HEVC standard are studying future video coding technologies for the successor of HEVC in a joint collaboration effort known as the Joint Video Exploration Team (JVET). The Joint Exploration Model (JEM) contains HEVC tools and new added tools selected by this JVET group. In particular, this software contains a motion information derivation at decoder side algorithm to encode efficiently the motion information. The list of additional tools is described in a document referenced as JVET-F1001.

The motion vector derivation at decoder side is denoted as Pattern matched motion vector derivation (PMMVD) in document JVET-F1001. The PMMVD mode in the JEM is a special merge mode based on Frame-Rate Up Conversion (FRUC) techniques. With this mode, motion information of a block is not signalled but derived at decoder side.

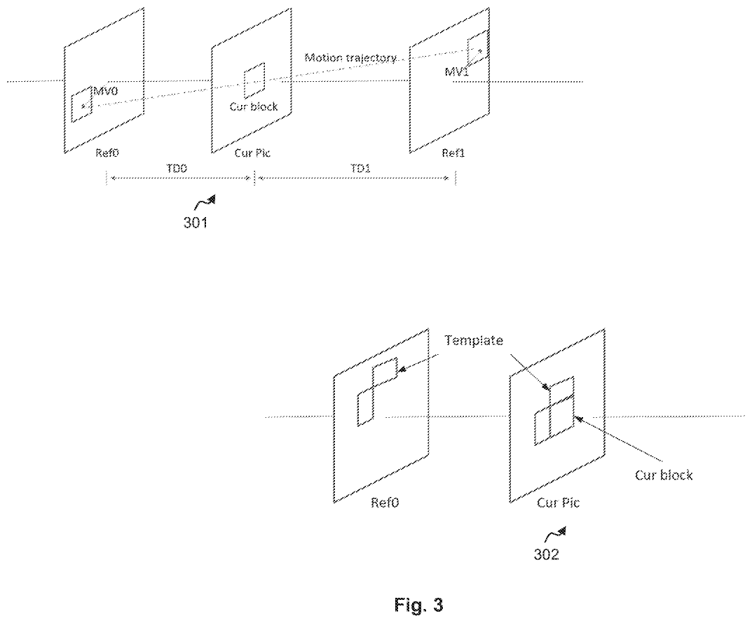

Two types of search are possible with the current version of the JEM: the template matching and the bilateral matching. FIG. 3 illustrates these two methods. The principle of the bilateral matching 301 is to find the best match between two blocks along the motion trajectory of the current coding unit.

The principle of the template matching 302 is to derive the motion information of the current coding unit by computing the match cost between the reconstructed pixels around the current block and the neighboring pixels around the block pointed by the evaluated motion vector. The template corresponds to a pattern of neighbouring pixels around the current block and to the corresponding pattern of neighbouring pixels around the predictor block.

For both matching types (template or bilateral), the different matches cost computed are compared to find the best one. The motion vector or the couple of motion vectors that obtain the best match is selected as derived motion information. Further details can be found in JVET-F1001.

Both Matching methods offer the possibility to derive the entire motion information, motion vector, reference frame, type of prediction. The motion information derivation at decoder side, noted “FRUC” in the JEM, is applied for all HEVC inter modes: AMVP, Merge and Merge Skip.

For AMVP all the motion information is signalled: uni or bi prediction, reference frame index, predictors index motion vector and the residual motion vector, the FRUC method is applied to determine a new predictor which is set at the first predictor if the list of predictor. So it has the index 0.

For Merge and Merge Skip mode, a FRUC flag is signalled for a CU. When the FRUC flag is false, a merge index is signalled and the regular merge mode is used. When the FRUC flag is true, an additional FRUC mode flag is signalled to indicate which method (bilateral matching or template matching) is to be used to derive motion information for the block. Please note that the bilateral matching is applied only for B frames and not for P frames.

For Merge and Merge Skip mode, a motion vector field is defined for the current block. It means that a vector is defined for a sub-coding unit smaller than the current coding unit. Moreover, as for the classical Merge one Motion vector for each list can form the motion information for a block.

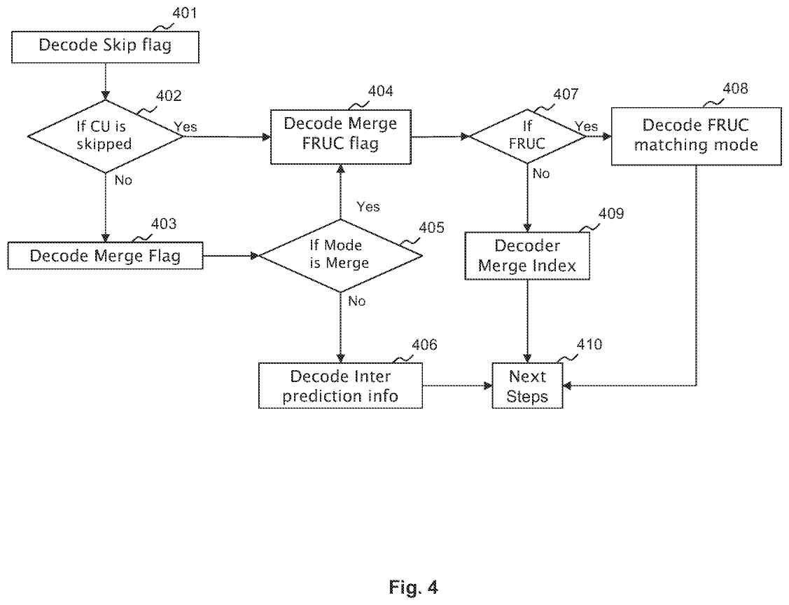

FIG. 4 is a flow chart which illustrates this signaling of FRUC flag for the Merge modes for a block. A block can be a coding unit or a prediction unit according to the HEVC wording.

In a first step 401, the Skip flag is decoded to know if the coding unit is encoded according to the Skip mode. If this flag is false, tested in step 402, the Merge Flag is then decoded in a step 403 and tested in a step 405. When the coding unit is encoded according to Skip or Merge mode, the Merge FRUC flag is decoded in a step 404. When the coding unit is not encoded according to Skip or Merge mode, the intra prediction info of the classical AMVP inter modes are decoded in a step 406. When the FRUC flag of the current coding unit is true, tested in a step 407, and if the current slice is a B slice, the matching mode flag is decoded in a step 408. It should be noted that bilateral matching in FRUC is only available for B slices. If the slice is not a B slice and FRUC is selected, the mode is necessarily template matching and the matching mode flag is not present. If the coding unit is not FRUC the classical Merge index is then decoded in a step 409.

The current invention is related to the signaling of the FRUC merge Flag as decoded in step 404.

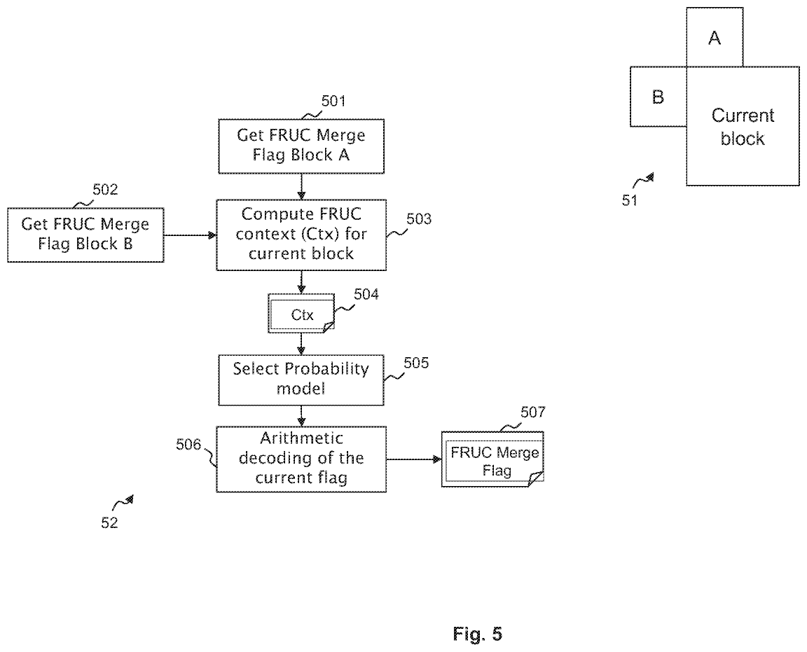

FIG. 5 illustrates the FRUC merge flag decoding of module 404. As HEVC standard, the JEM software uses the CABAC for the entropy coding as many variables of an HEVC bitstream.

CABAC is a context adaptive binary arithmetic coding. The principle is to encode symbols according to their probabilities of presence in the bitstream. Symbols with a high probability of presence in the bitstream are encoded with fewer bits, while less probable symbols are encoded with more bits. The probabilities are not fixed but adaptively determined while encoding. Moreover, several probabilities are contemplated depending on the context. For example, when the context indicates that the encoded flag seems stable in the bitstream locally, the probability of a given flag to correspond to its neighbor's value is high. The context is used to choose one of the probability model among several probability models available.

This figure illustrates the context derivation of the FRUC merge flag for the arithmetic coding. The context of the FRUC merge flag depends on the flag value of the neighboring block A and the value of the neighboring block B as illustrated in 51.

The FRUC Merge Flag of the neighboring block A is extracted from the memory in a step 501 while the FRUC Merge Flag of Block B is extracted in a step 502. Then the context (Ctx) 504 for encoding the FRUC Merge Flag of the current block is computed in a step 503. The formula to obtain the context value is:

Ctx=(Fruc flag==1 for Block A)+(Fruc flag==1 for Block B);

So the Ctx value can be equal to 0, 1 or 2. Its value is 0 when both FRUC Merge flags of the neighboring blocks are equal to 0. Its value is 1 when only one of these FRUC flags is equal to 1. And its value is 2 when both these FRUC Merge flags are equal to 1. The context is used to select, in a step 505, among the three probability models to be used in step 506 to encode the current FRUC Merge Flag 507.

Note that “A==B” means if A is equal to B then 1 else 0. In the same way “A!=B” means if A is different to B then 1 else 0.

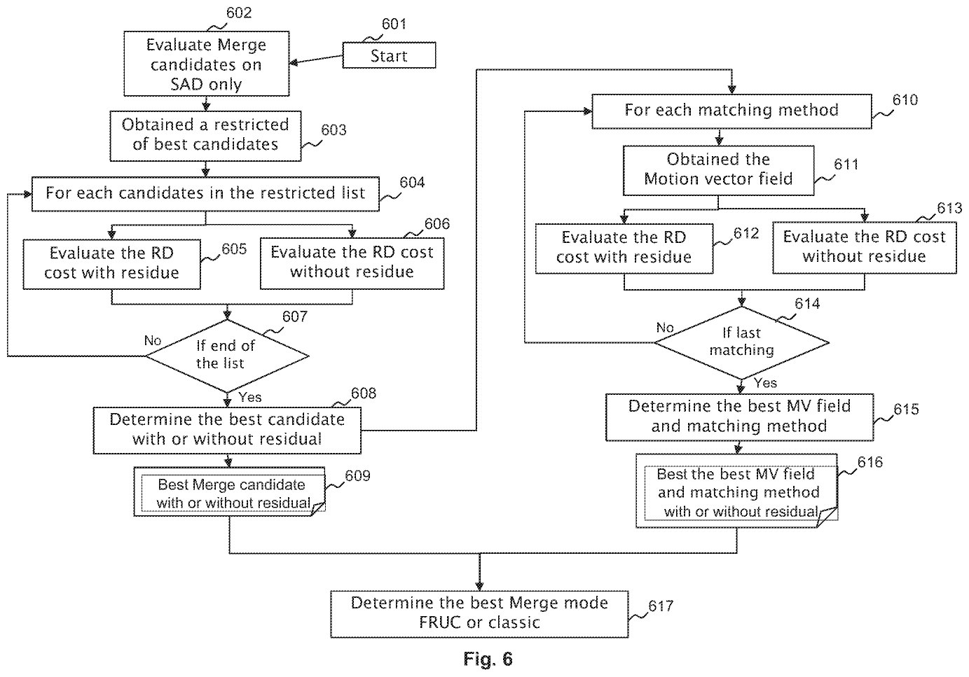

The FRUC Merge mode is competing at encoder side with the classical Merge mode (and other possible Merge). FIG. 6 illustrates the current encoding mode evaluation method in the JEM. First the classical Merge mode of HEVC is evaluated in a step 601. The candidate list is first evaluated with simple SAD (Sum of Absolute Difference) between the original block and each candidates of the list in a step 602. Then a real rate distortion (RD) cost of each candidates of a list of restricted candidates, illustrated by steps 604 to 608, is evaluated. In the evaluation, the rate distortion with, step 605, and a rate distortion without a residual, step 606, are evaluated. At the end, the best merge candidate is determined in step 609, this best merge candidate may have a residual or not.

Then the FRUC Merge mode is evaluated in steps 610 to 616. For each matching method, step 610, namely the bilateral and template matching, the motion vector field for the current block is obtained in a step 611 and full rate distortion cost evaluations with and without a residual are computed in steps 612 and 613. The best motion vector 616, with or without residual, is determined in step 615 based on these rate distortion costs. Finally, the best mode between the classical Merge mode and the FRUC Merge mode is determined in step 617 before possible evaluation of other modes.

The rate dedicated to the encoded FRUC merge flag in the bitstream cannot be neglected compared to the gain obtained from the use of the FRUC mode. In some cases, the gain may even be cancelled by the size of the encoded FRUC merge flag.

The known context derivation process used for encoding the FRUC merge flag has been described above, the context is computed according to the equation: Ctx=(Fruc flag==1 for Block A)+(Fruc flag==1 for Block B). This context derivation method is only based on the FRUC merge flag information. Inventors have determined that alternative context derivation processes based on other data than only the FRUC merge flag are more relevant and lead to a more efficient encoding of the FRUC merge flag.

A decoder side motion vector derivation method (DMVD), such as the FRUC mode, aims avoiding the coding of motion information when this information is predictable. This is especially true when these methods are based on a list of spatial and temporal neighboring motion vectors as candidates for the current motion information.

In one embodiment of the invention, the determination of the context for an information related to the use or not of the decoder side motion vector derivation method is based on the already decoded information of the current block (or neighboring block) which characterizes a constant motion activity.

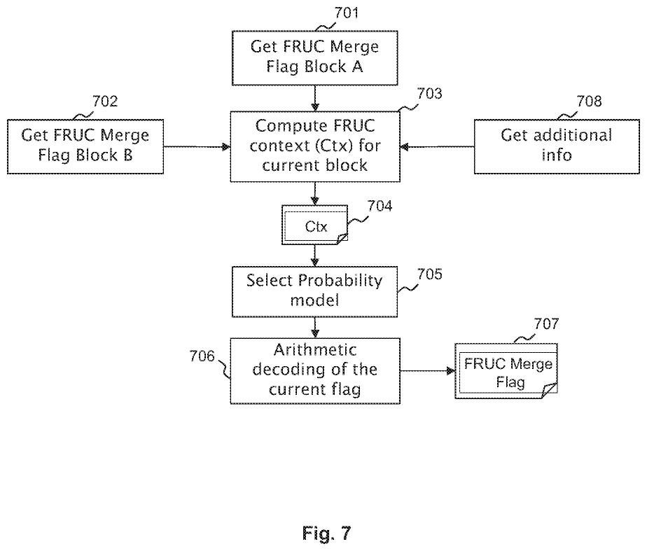

FIG. 7 illustrates this embodiment. This figure is based on FIG. 5 with the additional module 708. This module 708 aims at providing additional information to the module 703 that determine the context for encoding the FRUC merge flag.

In one embodiment, this additional information corresponds to the current Skip flag information. In an exemplary embodiment, the context is the sum of the Skip flag value and the value of Fruc flag of at least one of the neighboring block as the following formula:

Ctx=(Fruc flag==1 for Block A)+(Fruc flag==1 for Block B)+Skip flag;

The use of Skip information improves the coding of an information of the use or not of a DMVD method as FRUC Merge Flag. Indeed, in a video sequence, the Skip mode is selected on background or object without any deformation. This corresponds to the area where the DMVD methods are efficient.

In one embodiment, the context for coding the FRUC merge flag is determined based on the shape of the current block. For example the additional information may be based on the height and the width of the current block. More specifically, if the block is a square block or not. This can be combined with the value of the FRUC Flag of the neighboring blocks as given, for example, by the following formula:

Ctx=(FRUC flag==1 for Block A)+(FRUC flag==1 for Block B)+(Block height==Block width);

This can also be applied to the context determination for encoding the AMVP predictor index. In the HEVC standard, the predictor index is only one bit because the number of AMVP predictor is equal to 2. This index is coded with the arithmetic coding but without context. With this embodiment the context can be obtained by the following formula:

Ctx=(Block height==Block width);

But the formula can also be:

Ctx=(Block height!=Block width);

These embodiments are efficient because generally when an area is split based on square block it corresponds to a constant motion area. The other way round, the rectangular blocks are found on frontier between two motions to obtain a more precise splitting of the motion information.

In another embodiment, an information relative to the size is determined for the current block. This size information can be the minimum between the height and the width of the current block or the maximum. This size information can also be the number of pixels in the blocks. The context Ctx for the Fruc merge flag can be set based on the following formula for example:

Ctx=(FRUC flag==1 for Block A)+(FRUC flag==1 for Block B)+(size_info>>2);

Where “>>” is the right shift operator.

This context determination can also be applied to the context determination for the encoding of the AMVP predictor index. These embodiments are efficient because the size of blocks is larger for constant motion area than complex motion area. So it is relevant to separate the probabilities for the arithmetic coding based on the current block size information value.

In one embodiment, the context depends on the existence and on the values of the neighbouring decoded motion vectors. For example, when one or more neighbouring motion vectors doesn't exist or when its value is large, the context takes one value and when the neighbouring motion vectors exist and are small, the context takes another value. If the neighbouring motion vector doesn't exist, it corresponds to a block predicted with the INTRA mode or to an image border. For both cases, the motion is less predictable. Of course when the motion vector value is large there is less chance to predict correctly the motion, so the FRUC method should be less efficient.

In another embodiment, the context for encoding the FRUC flag is obtained by the following formula:

Ctx=(Fruc flag==1 for Block A OR (A_is_AMVP AND MPX=0 AND MVD=(0,0)))+(Fruc flag==1 for Block B OR (B is_AMVP AND MPX=0 AND MVD=(0,0)));

Where MPX is the motion vector predictor index and MVD is the motion vector difference or the motion vector residual.

This advantage of this embodiment is that the neighboring blocks coded in AVMVP with a motion vector residual (MVD) equal to 0 and a predictor index (MPX) equal to 0 are considered. Such block has characteristics similar to a FRUC Merge block without the Sub-CU level estimation.

In a preferred embodiment, when the current block is not a skip block and not a square block the context is equal to 0. Otherwise if the current block has the Skip flag equal to 1, the context is set equal to 1. If the current block is a square block, the context is set equal to 2. If both these conditions are true, the context is set equal to 3. Then the value of the FRUC flag for the neighboring block is also taken into account.

So when the current block is not a skip block and not a square block the context is obtained by the following formula:

Ctx=(Fruc flag==1 for Block A)+(Fruc flag==1 for Block B)+Skip flag+(Block height==Block width)*2;

In another embodiment, the additional information used to determine the context value for encoding the FRUC merge flag is based on the neighboring blocks information only (and not on the decoded information of the current block). This simplifies the design for hardware implementation because it reduces the parsing dependency between data.

As for the previous embodiments the aim is to detect easily where the motion is static or constant.

For example, the context value can be obtained with the following formula:

Ctx=(Fruc_flag_A==1+Block_height_A==Block_width_A+Skip_flag_A)+(Fruc_flag_B==1+Block_height_B==Block_width_B+Skip_flag_B);

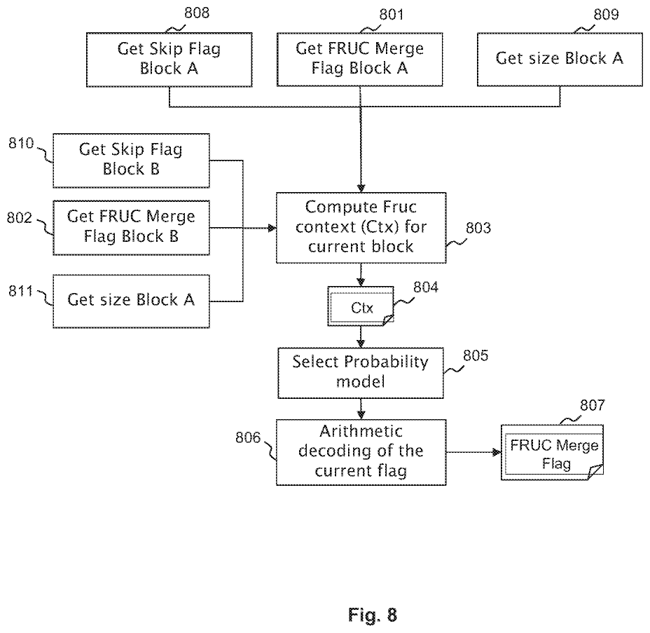

FIG. 8 illustrates this embodiment.

In steps 808, 801 and 809, information for the A neighbor are obtained, namely the Skip Flag, the FRUC merge flag and the size information.

In steps 810, 802 and 811, the same information is obtained for neighbor block B.

This information is used to determine the context 804 in step 803.

Steps 805, 806 and 807 are similar to corresponding steps in FIG. 7.

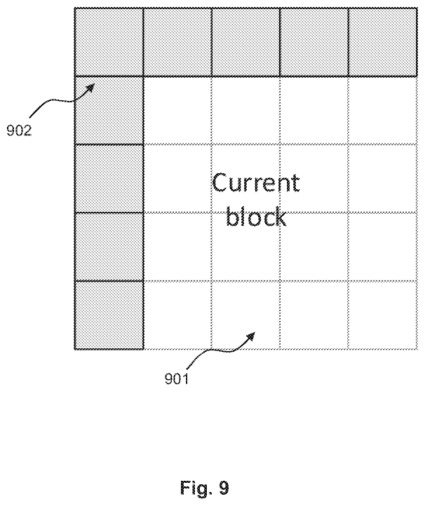

A decoder side motion vector derivation method, such as FRUC merge mode, is efficient when the template used for the estimation contains enough information to determine a motion vector. In the following embodiment illustrated by FIG. 9, the selection of the FRUC Merge mode or its context coding for a coding unit 901, illustrated by the white pixels, depends on the value of its neighboring pixels 902, illustrated by the grey pixels.

In one embodiment when the content of the neighboring pixels 902 is flat the FRUC Merge method can't be selected and no FRUC Merge flag is decoded.

In one embodiment, when the content of the neighboring pixels 902 is flat, the context is set equal to 0 otherwise it is set to another value depending on other data, this value being above 0.

In one embodiment, when the content of the neighboring pixels 902 is flat the Fruc merge mode is not evaluated at encoder side in order to reduce the encoding time.

The pixels are considered as flat when the sum of gradient or absolute gradient is less than a threshold. The gradient of an image is a directional change in intensity. This can be obtained by the derivatives in horizontal and vertical directions. The sum of gradient refers here to the sum of absolute value for both direction for all pixel where the derivative can be computed.

In some embodiments, the whole encoding method is improved.

The FRUC Merge mode has similarities with the classical Merge mode. In the following embodiments, this is exploited at encoder side to save encoding time or bitrate.

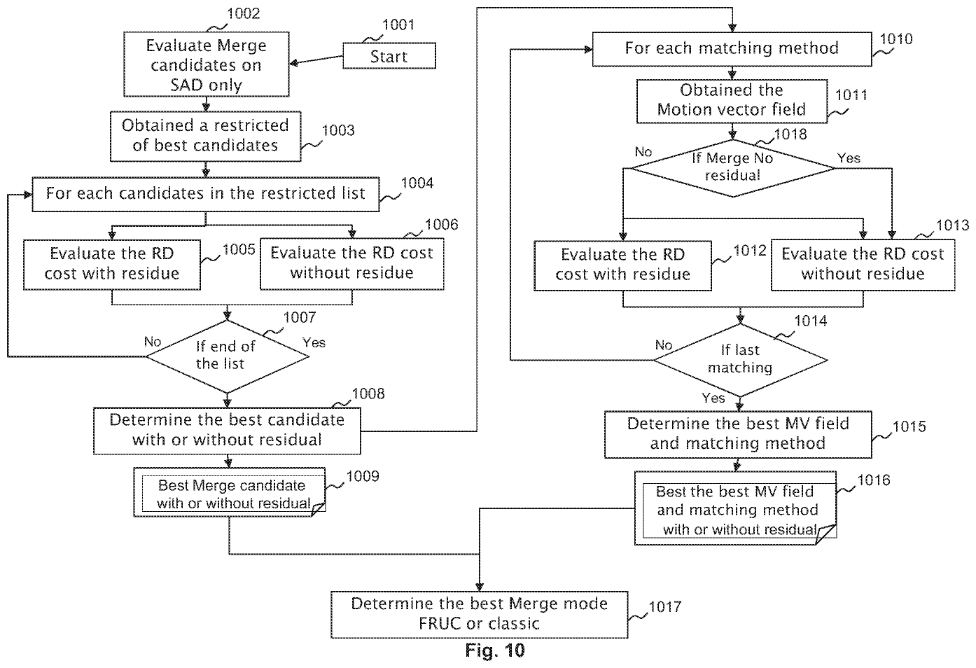

FIG. 10 illustrates one embodiment of the encoding method. This embodiment is an alternative embodiment of the encoding mode evaluation method described in relation to FIG. 6. As many steps are similar, we describe only step 1018 that has been introduced. All other steps are identical to the corresponding steps in FIG. 6 and are identically referenced.

In this embodiment, the results of the classical Merge Mode in step 608 is tested in step 1018 to know if it has a residual. If it is not the case the rate distortion cost for the FRUC Merge mode with the residual, step 612, will not be evaluated for the current block. This embodiment allows saving encoding time with a small degradation of coding efficiency.

In another embodiment, the FRUC Merge mode is evaluated first and then the Merge mode is evaluated. This gives a coding efficiency improvement in the JEM. Indeed, the FRUC merge mode is more selected than the merge mode at low bitrates. When it is tested first its selection increases and consequently, it reduces its signaling bitrate thanks to the arithmetic coding which becomes more favorable to obtain gains.

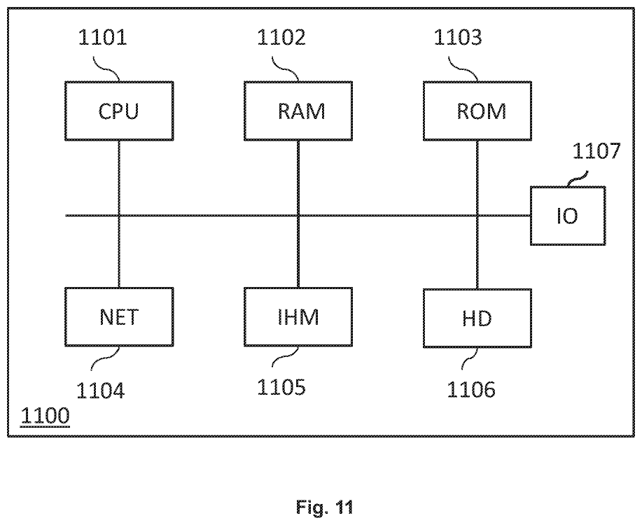

FIG. 11 is a schematic block diagram of a computing device 1100 for implementation of one or more embodiments of the invention. The computing device 1100 may be a device such as a micro-computer, a workstation or a light portable device. The computing device 1100 comprises a communication bus connected to:
a central processing unit 1101, such as a microprocessor, denoted CPU;
a random access memory 1102, denoted RAM, for storing the executable code of the method of embodiments of the invention as well as the registers adapted to record variables and parameters necessary for implementing the method for encoding or decoding at least part of an image according to embodiments of the invention, the memory capacity thereof can be expanded by an optional RAM connected to an expansion port for example;
a read only memory 1103, denoted ROM, for storing computer programs for implementing embodiments of the invention;
a network interface 1104 is typically connected to a communication network over which digital data to be processed are transmitted or received. The network interface 1104 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 1101;
a user interface 1105 may be used for receiving inputs from a user or to display information to a user;
a hard disk 1106 denoted HD may be provided as a mass storage device;
an I/O module 1107 may be used for receiving/sending data from/to external devices such as a video source or display.

The executable code may be stored either in read only memory 1103, on the hard disk 1106 or on a removable digital medium such as for example a disk. According to a variant, the executable code of the programs can be received by means of a communication network, via the network interface 1104, in order to be stored in one of the storage means of the communication device 1100, such as the hard disk 1106, before being executed.

The central processing unit 1101 is adapted to control and direct the execution of the instructions or portions of software code of the program or programs according to embodiments of the invention, which instructions are stored in one of the aforementioned storage means. After powering on, the CPU 1101 is capable of executing instructions from main RAM memory 1102 relating to a software application after those instructions have been loaded from the program ROM 1103 or the hard-disc (HD) 1106 for example. Such a software application, when executed by the CPU 1101, causes the steps of the method according to the invention to be performed.

Any step of the methods according to the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1-13. (canceled)

14. A method for encoding video data comprising frames, each frame being split into blocks of pixels, the method comprising for a block of pixels the comparison of a plurality of modes, the plurality of modes comprising at least a Merge mode and a mode where motion information is obtained by a decoder side motion vector derivation method:
determining a best candidate for a motion information using the Merge mode;
determining if the best candidate has a residual;
determining a best candidate using the mode where motion information is obtained by a decoder side motion vector derivation method; wherein:
if the best candidate using the Merge mode has no residual then, when determining the best candidate using the mode where motion information is obtained by a decoder side motion vector derivation method, candidates with residual are not evaluated.

15. The method of claim 14, wherein determining the best candidate using the Merge mode, including calculating sum of absolute difference based on the block of pixels.

16. The method of claim 14, wherein determining the best candidate using the mode where motion information is obtained by a decoder side motion vector derivation method, including calculating sum of absolute difference based on the block of pixels.

17. An apparatus for encoding video data comprising frames, each frame being split into blocks of pixels, the apparatus configured to compare a plurality of modes for a block of pixels, the plurality of modes comprising at least a Merge mode and a mode where motion information is obtained by a decoder side motion vector derivation method, the apparatus comprising:
a first determining unit configured to determine best candidate for a motion information using the Merge mode;
a second determining unit configured to determine if the best candidate has a residual;
a third determining unit configured to determine a best candidate using the mode where motion information is obtained by a decoder side motion vector derivation method; wherein:
if the best candidate using the Merge mode has no residual then, when determining the best candidate using the mode where motion information is obtained by a decoder side motion vector derivation method, candidates with residual are not evaluated by the third determining unit.

18. The apparatus of claim 17, wherein the first determining unit is configured to determine the best candidate using the Merge mode, by calculating sum of absolute difference based on the block of pixels.

19. The apparatus of claim 17, wherein the third determining unit is configured to determine the best candidate using the mode where motion information is obtained by a decoder side motion vector derivation method, by calculating sum of absolute difference based on the block of pixels.

20. A non-transitory computer-readable storage medium storing instructions of a computer program for implementing a method according to claim 14.
